(19) United States
(12) Patent Application Publication
(10) Pub. No.: US 2003/0169742 A1
(43) Pub. Date: Sep. 11, 2003

(54) Communicating voice payloads between disparate processors

(76) Inventors: John M. Twomey, Limerick (IE); Michael A. O'Hanlon, Limerick (IE)

Correspondence Address: Timothy N. Trop, TROP, PRUNER & HU, P.C., STE 100, 8554 KATY FWY, HOUSTON, TX, 77024-1841, US

(21) Appl. No.: 10/092,109

(22) Filed: Mar. 6, 2002

(51) Int. Cl. H04L 12/56

(52) U.S. Cl. 370/395.1; 370/474

(57) ABSTRACT

Voice data transmissions between time division multiplexed streams and asynchronous transmission mode cell streams may be facilitated by supplying pre-formatted frames from a frame database. The frames may be filled with units that are preformatted in asynchronous transmission mode adaptation layer packet styles. These frames may then be forwarded from a time division multiplex processor to an asynchronous transmission mode adaptation layer processor that fills the ATM cells with the ATM payloads.

### BACKGROUND

This invention relates generally to communicating voice payloads.

Time division multiplexing (TDM) has been used for some time to facilitate voice communications. Each circuit is allocated a fixed amount of time on a channel in TDM. Thus, TDM is a synchronous system. In TDM, the bandwidth goes unused when a circuit has nothing to transmit.

Asynchronous transfer mode (ATM) uses cell switching or data transmission in fixed size units called cells. ATM is asynchronous because any circuit can transmit at any point in time. Thus, bandwidth does not go unused when a circuit has nothing to send in its allocated time period.

Since both time division multiplexing and asynchronous transfer mode systems continue to exist, it would be desirable to provide an network processor with the capability to transfer data between ATM and TDM systems.

### BRIEF DESCRIPTION OF THE DRAWINGS

FIG. 1 is a schematic depiction of one embodiment of the present invention in which data is passed upstream from a TDM stream to an ATM cell stream in accordance with one embodiment of the present invention;

FIG. 2 is a flow chart for software utilized by the TDM processor in accordance with one embodiment of the present invention;

FIG. 3 is a flow chart for software utilized by the AAL2 processor in accordance with one embodiment of the present invention;

FIG. 4 is a flow chart for software for accomplishing refresh in accordance with one embodiment of the present invention;

FIG. 5 is a depiction of a frame in accordance with one embodiment of the present invention;

FIG. 6 is a schematic depiction of the transfer of data from an ATM cell stream to a TDM stream in accordance with one embodiment of the present invention;

FIG. 7 is a flow chart for software utilized by AAL2 processor in accordance with one embodiment of the present invention; and

FIG. 8 is a flow chart for software utilized by the TDM processor in accordance with one embodiment of the present invention.

### DETAILED DESCRIPTION

The asynchronous transfer mode (ATM) uses adaptation layers (AALs) to adapt applications to what is available from an ATM layer. The International Telecommunications Union-Telecommunications has adopted a standard for an adaptation layer that handles cellular data with a variable bit rate. See I.363.2(9/97) B-IDSN ATM Adaptation Layer Specification: Type 2 AAL (AAL2).

The AAL2 packet format involves a header with a channel identifier (CID) that identifies individual AAL2 channels within an AAL2 link. The header also includes a length indicator (LI) that indicates that actual length of a payload. The header may also include a user-to-user indicator (UUI) that allows upper layers to convey information. Finally, the header may include a header error correction field (HEC) to detect transmission errors.

In accordance with one embodiment of the present invention, “units” are used to store AAL2 packets for transporting voice payloads. A unit may contain AAL2 header contents and a payload. A unit may include a spare field (that may be five bytes in one embodiment), a CID field (that may be eight bits in one embodiment), an LI field (that may be six bits in one embodiment), a UUI field (that may be five bits in one embodiment), an HEC field (that may be five bits in one embodiment) and a payload (that may be sixty-four bytes in one embodiment). Thus, a unit may have a total of seventy-two bytes in one embodiment.

A “unit list” transports a bundle of units. The number of units in the list advantageously matches the number of voice channels served by a time division multiplex (TDM) stream that, in one embodiment, may be thirty units. A “unit pointer” stores the start address of a unit or a field within a unit. A TDM channel is directly associated with a pointer. A “unit pointer list” transports the maximum number of unit pointers that can be associated with the unit list which is thirty in one embodiment of the present invention. In one embodiment, each unit pointer may take up four bytes.

A “unit frame” is an entity used to collectively transport a pointer list and a unit list. The frame may include an active unit counter to indicate how many active units exist in the list. There may be one active unit for each active voice call. The frame may also contain a refresh indicator to track the validity of the pointer list contents and all of the unit AAL2 header contents. The refresh indicator is updated when a voice call is connected or disconnected. In one embodiment, the pointer list may be allocated one hundred and twenty eight bytes to store thirty two four byte unit pointers, the refresh indicator may be allocated one byte, the CID unit count may be allocated one byte, the spare field may be allocated two bytes and the unit list may be allocated 2,160 bytes. The spare bytes may also be used to ensure that the unit list starts on a four byte boundary in one embodiment.

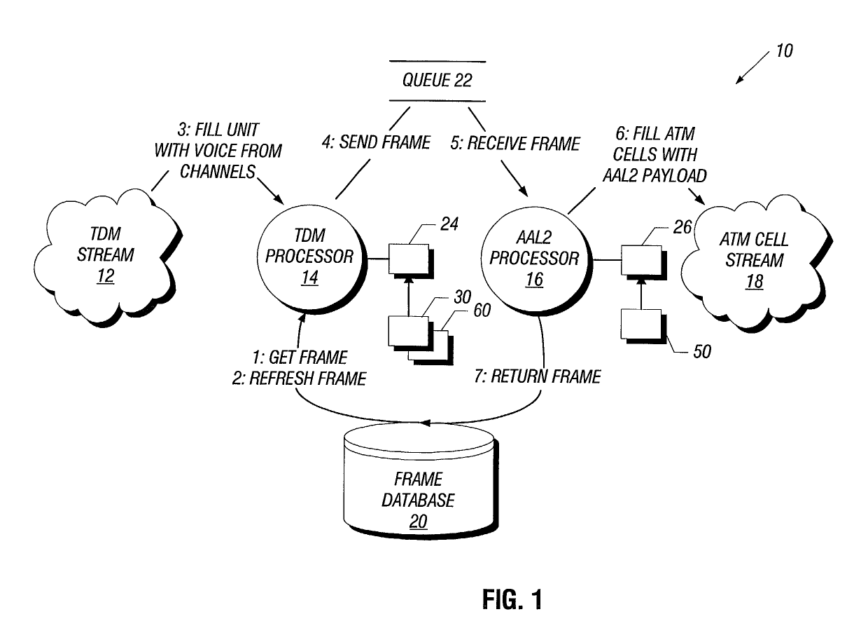

Referring to FIG. 1, the upstream transfer of data from a TDM stream 12 to an ATM cell stream 18, in accordance with one embodiment of the present invention, may be implemented in a network processor 10. The transfer may begin with the TDM processor 14 getting a frame from a frame database 20, as indicated at 1 in FIG. 1. The frame is refreshed (as indicated at 2) only if the frame's refresh indicator value does not match the refresh counter value of the TDM processor 14. The TDM processor 14 refresh counter value is incremented each time a voice call is connected or disconnected. The refresh indicator value is set to that of the refresh counter on completion of a refresh.

Next, the TDM processor 14 reads one data byte from each active TDM channel in the TDM stream 12 and writes it into the unit pointed to by a pointer associated with the TDM channel as indicated at 3. This action is repeated N times where N is the number of byte samples needed in a voice payload buffer. A typical value for N is forty-four which represents forty-four times one-hundred twenty microseconds or 5.5 milliseconds of voice data.

As indicated at 4 in FIG. 1, the frame is sent to the AAL2 processor 16 via a frame queue 22. The AAL2 processor 16 receives the frame from the queue 22 as indicated at 5. The processor 16 extracts the AAL2 packet from each unit in the frame and inserts the packet into the new ATM cell for transmission into the ATM cell stream 18, as indicated at 6 in FIG. 1. The processor 16 then returns the frame to the frame database 20 as indicated at 7.

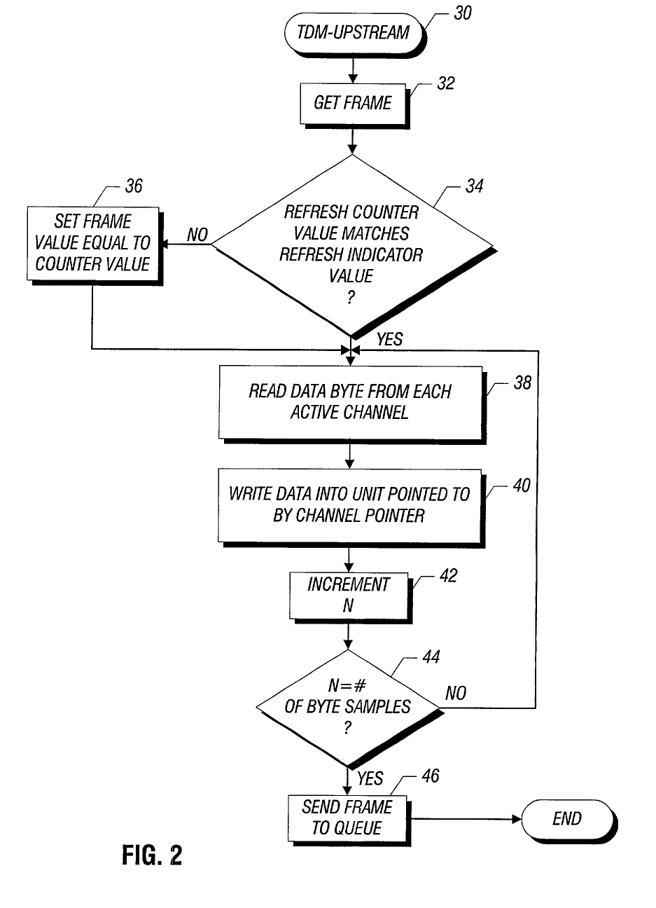

In one embodiment, the transfer of voice data from the TDM stream 12 to the ATM cell stream 18 may be implemented by software 30 stored on a storage 24 associated with the TDM processor 14 as shown in FIG. 1. The software 30, further illustrated in FIG. 2, begins by getting a frame as indicated in block 32. A check at diamond 34 determines whether the refresh counter value matches the refresh indicator value in the unit. If so, a data byte is read from each active channel as indicated in block 38. If the refresh counter value does not match the refresh indicator value, the indicator value may be set equal to the counter value as indicated in block 36. Data is written into the unit pointed to by the channel pointer as indicated in block 40. A variable N is incremented as indicated in block 42 and a check at diamond 44 determines whether N equals the number of byte samples that are needed. If not, the flow iterates. Otherwise, the frame is sent to the queue as indicated in block 46.

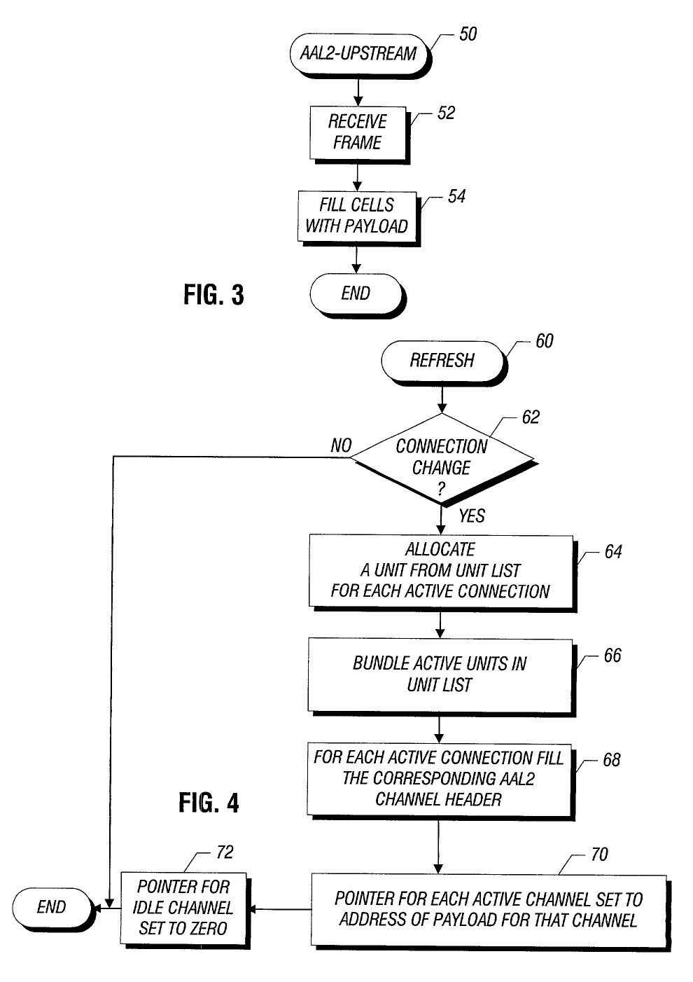

The AAL2 upstream software 50, shown in FIG. 1, may be stored on a storage 26 associated with the AAL2 processor 16 in accordance with one embodiment of the present invention. Referring to FIG. 3, the software 50 receives a frame as indicated in block 52 and fills cells with the payload as indicated in block 54.

A frame is refreshed if a voice call has been connected or disconnected. A refresh updates the unit pointer, unit association and the AAL2 header content stored in each unit. Refresh may be used with upstream software 50.

Referring to FIG. 4, in one embodiment, the refresh software 60 begins by determining if a connection change has occurred, as indicated in diamond 62. Each pointer in the pointer list is associated with a TDM voice channel in the TDM stream as indicated in block 64. That association is fixed. For example, pointer no. 10 is associated with a voice channel 10. One unit is allocated from the pointer list for each active connection. Active units in the unit list are bundled together to simplify the AAL2 packet extraction performed by the AAL2 processor 16 as indicated in block 66. For example, if there are five active connections, then the first five units in the list are allocated.

For each active connection, the unit AAL2 header is filled with the corresponding AAL2 CID, UUI, and LI as indicated in block 68. The pointer associated with each active channel contains the address of the AAL2 packet payload of the unit allocated to that channel as indicated in block 70. The unit pointer for each channel is set to zero (block 72).

With this refresh mechanism, in accordance with one embodiment of the present invention, all of the frame contents, except the packet payloads, are defined only once each call connect or disconnect. That is, the frame contents may be reused, saving processor cycles.

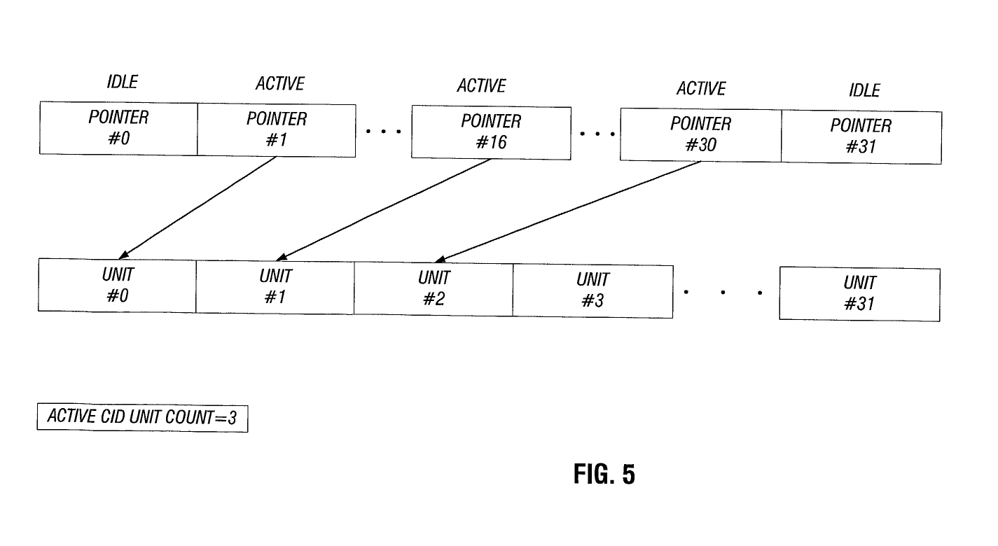

Referring to FIG. 5, an illustrated unit frame has three active voice calls which go into units 0, 1, and 2. A TDM channel number is associated with a unit pointer with the same number. For example, TDM channel 0 is associated with unit pointer 0. The voice channels 1, 16 and 30 are the active voice channels while all of the other channels, including the channels 0 and 31, are idle. Thus, the active unit count is equal to three. The unused pointers have a value equal to zero. The pointers (1, 16, 30) for the active channels point to corresponding units (0, 1, 2) in the frame.

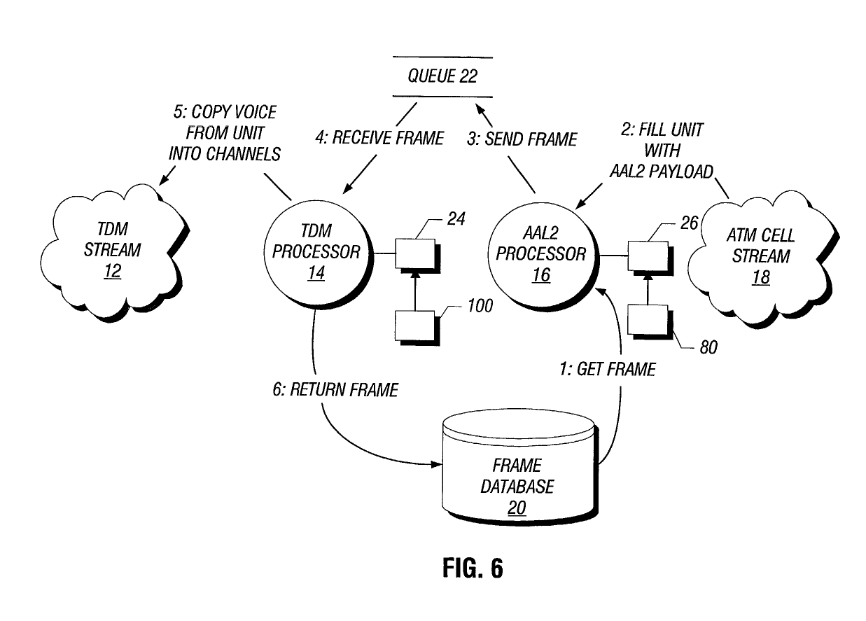

Referring to FIG. 6, in accordance with one embodiment of the present invention, the downstream transfer from an ATM cell stream 18 to the TDM stream 12 begins with the AAL2 processor 16 getting a frame from the frame database 20 as indicated at 1. The processor 16 stores the AAL2 packets received from the ATM cell stream 18 into units, as indicated at 2, until the unit list is full and the unit list fill timer has expired, as indicated at 2. The unit fill timer normally expires at a time (such as 5.5 ms) that matches the voice payload sample size.

The AAL2 cell with a CID matching the CID associated with an active TDM channel is received. The CID in each unit is used to identify the TDM channel associated with a voice call. A pointer for that TDM channel is set to the address of the AAL2 packet payload in the unit, namely the voice payload. The frame is sent to the TDM processor 14 via the queue 22 as indicated at 3.

The TDM processor 14 receives a frame from the queue 22 as indicated at 4. The processor 14 writes one data byte from each unit's payload into the associated TDM channel in the TDM stream 12 as indicated at 5. This action is repeated N times where N is the number of byte samples needed in a voice payload buffer. The processor 14 returns the frame to the frame database 20 as indicated at 6.

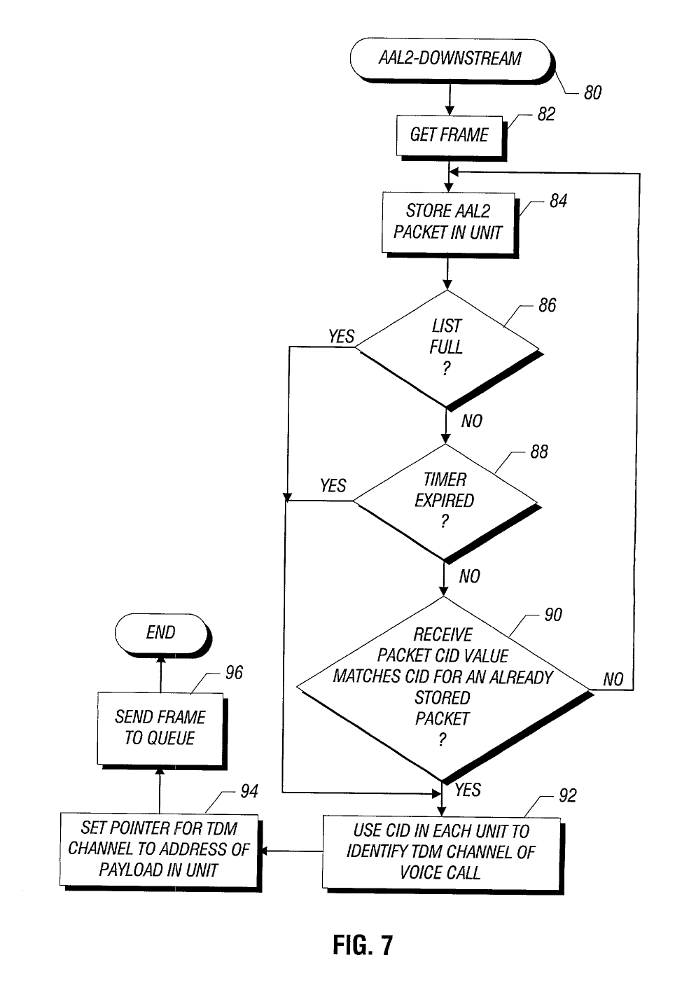

The AAL2 downstream software 80 may be stored in the storage 26 associated with the AAL2 processor 16 in accordance with one embodiment of the present invention. Referring to FIG. 7, the software 80, in one embodiment, may begin by getting a frame as indicated in block 82. An AAL2 packet is stored in a unit as indicated in block 84. If the frame list is not full, then a check at diamond 88 determines whether the unit list fill timer has expired. If not, a check at diamond 90 determines whether or not a packet has been received with a CID that matches that of an already stored packet. The TDM channel number is used to index the unit pointer list. For a 32 channel TDM system, channels are numbered 0 to 31. A look up table is used to associate a CID with each TDM channel. The index to the table is a CID and the content of the indexed entry is a TDM channel number. This table is updated each time there is an AAL2 channel connect or disconnect.

If so, the flow moves to block 92 where a CID in each unit is used to identify the TDM channel of a voice call. The pointer for the TDM channel is set to the address of the payload of the unit at block 94 and the frame is sent to the queue as indicated in block 96.

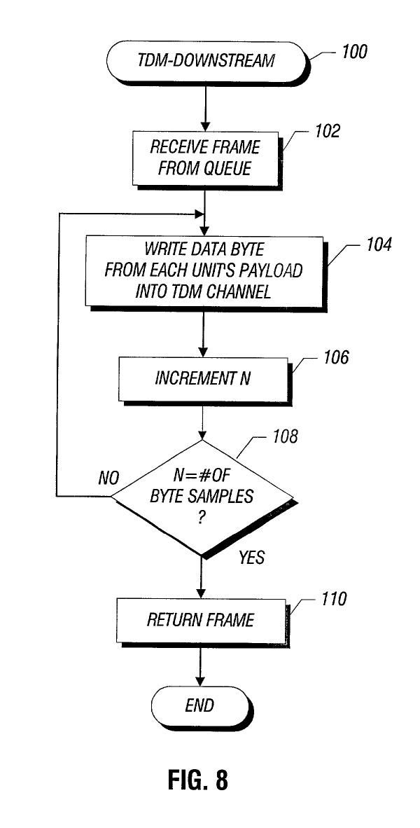

The TDM downstream software 100 may be stored in the storage 24 associated with the TDM processor 14. The software 100 may begin by receiving a frame from the queue as indicated in block 102 in FIG. 8, in one embodiment. A data byte is written from each unit's payload into the TDM channel as indicated in block 104. A variable N is incremented in block 106 and a check a diamond 108 determines whether N equals the needed number of byte samples. If so, the frame is returned as indicated in block 110. Otherwise, the flow cycles back to block 104.

In accordance with some embodiments of the present invention, recycling of pre-formatted unit frames makes interworking of voice payloads between TDM and ATM interfaces more efficient. Upstream voice payloads may be written directly by the TDM processor 14 into pre-formatted AAL2 packets. Downstream voice payloads are read directly by the TDM processor from AAL2 packets. There need be no copying of voice payload data. The downstream voice payload may be easily extracted and queued in some embodiments of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
obtaining a pre-formatted frame; and
filling the frame with voice data formatted as asynchronous transfer mode adaptation layer packets.

2. The method of claim 1 including obtaining a preformatted frame from a database of frames.

3. The method of claim 2 including receiving voice data from a time division multiplex stream and processing said data in a time division multiplex processor.

4. The method of claim 3 including determining whether a refresh value associated with said processor matches a refresh value associated with said frame.

5. The method of claim 4 including setting the frame value equal to the processor refresh value if the values do not match.

6. The method of claim 3 including filling the frame with a plurality of units of voice data, from said time division multiplex stream.

7. The method of claim 1 including filling the frame with voice data from an asynchronous transfer mode adaptation layer packet.

8. The method of claim 7 including storing the packet in a unit and providing a plurality of units in a frame.

9. The method of claim 8 including determining whether the frame is full.

10. The method of claim 9 including determining whether a timer has expired during the filling of the frame.

11. The method of claim 9 including determining whether data has been received with a connection identifier that matches the connection identifier of data already stored.

12. The method of claim 11 including using the connection identifier in each unit to identify a time division multiplex channel of a voice call.

13. The method of claim 12 including setting a pointer for a time division multiplex channel to the address of a payload in a unit.

14. The method of claim 7 including using an asynchronous transfer mode adaptation layer packet processor to fill the frame.

15. An apparatus comprising:
a processor; and
a frame database, to store pre-formatted frames, said processor accessing frames from said frame database to fill the frames with voice data.

16. The apparatus of claim 15 wherein said processor is a time division multiplex processor and said frame database stores pre-formatted frames so that the processor can access the frames from the frame database to fill the frames with voice data from time division multiplex channels.

17. The apparatus of claim 16 wherein said processor keeps a refresh count each time a call is made or disconnected.

18. The apparatus of claim 16 wherein said processor reads data from each active channel and writes data into said frames.

19. The apparatus of claim 18 wherein said data in said frame is divided into units which correspond to asynchronous transfer mode packets.

20. The apparatus of claim 19 wherein the processor sends the frame to a queue after it has been filled.

21. The apparatus of claim 15 wherein said processor is an asynchronous transfer mode adaptation layer processor that fills the frame database with voice data from an asynchronous transfer mode cell stream.

22. The apparatus of claim 15 wherein said processor is an asynchronous transfer mode adaptation layer processor.

23. The apparatus of claim 22 wherein said apparatus includes a time division multiplex processor coupled to said asynchronous transfer mode adaptation layer processor.

24. An article comprising a medium storing instructions that enable a processor-based device to:
obtain a pre-formatted frame; and
fill the frame with voice data formatted as asynchronous transmission mode adaptation layer packets.

25. The article of claim 24 further storing instructions that enable the device to receive data from a time division multiplexed stream, to read data from each active channel and to write data into said frames.

26. The article of claim 25 further storing instructions that enable the processor-based device to determine whether a refresh value associated with the processor matches the refresh value associated with the frame.

27. The article of claim 26 further storing instructions that enable the processor-based device to set the frame refresh value equal to the processor refresh value if the values do not match.

28. The article of claim 25 further storing instructions that enable the processor-based device to fill the frame with a plurality of units of voice data from a time division multiplex stream.

29. The article of claim 24 further storing instructions that enable the device to receive data from an asynchronous transfer mode cell stream, to read data from said cells, and to place said data in a pre-formatted frame.

30. The article of claim 29 wherein said frame is provided to a time division multiplex processor that injects the voice data into a time division multiplex stream.
